(19) United States
(12) Patent Application Publication
(10) Pub. No.: US 2024/0215087 A1
(43) Pub. Date: Jun. 27, 2024

(54) IP-based UE Aggregation

(71) Applicant: Apple Inc., Cupertino, CA (US)

(72) Inventors: Pavan NUGGEHALLI, San Carlos, CA (US); Alexander SIROTKIN, Hod Hasharon (IL); Fangli XU, Beijing (CN); Haijing HU, Los Gatos, CA (US); Naveen Kumar R. PALLE VENKATA, San Diego, CA (US); Ralf ROSSBACH, Munich (DE); Sarma V. VANGALA, Campbell, CA (US); Sethuraman GURUMOORTHY, San Ramon, CA (US); Yuqin CHEN, Beijing (CN); Zhibin WU, Los Altos, CA (US)

(21) Appl. No.: 17/906,492

(22) PCT Filed: Sep. 24, 2021
(86) PCT No.: PCT/CN2021/120270

§ 371 Date: Sep. 16, 2022

(51) Int. Cl. H04W 76/14; H04W 28/02; H04W 76/20; H04W 80/02

(52) U.S. Cl. CPC H04W 76/14; H04W 28/0268; H04W 76/20; H04W 80/02

(57) ABSTRACT

A first user equipment (UE) is configured to establish a device-to-device (D2D) connection with a second UE, generate internet protocol (IP) packets for uplink (UL) transmission to a network and identifying a quality of service (QOS) flow for the packets, encapsulate each packet with a header comprising a Qos flow identifier (QFI), transmit a first portion of the encapsulated packets to the network via a first radio link and transmitting a second portion of the encapsulated packets to the second UE via the D2D connection for transmission to the network via a second radio link of the second UE.

### BACKGROUND

A user equipment (UE) may establish a connection to at least one of a plurality of different networks or types of networks, for example a 5G New Radio (NR) radio access technology (RAT). The UE may also be configured to communicate with a further UE, or multiple further UEs, via a device-to-device (D2D) connection, for example a wired connection, a wireless local area network (WLAN) link or a 3GPP-specified sidelink. In some cases (e.g., when the UEs are not proximate), the D2D link may be made secure, e.g., by creating an IPSec tunnel. The further UE (s) may additionally establish a network connection, for example on the same network as the UE.

Some UEs may operate in accordance with specifications that limit the bandwidth of uplink (UL) and/or downlink (DL) communications with the network. For example, some 3GPP specifications limit the transmit power of a UE to minimize human exposure to electromagnetic radiation, in accordance with regulations imposed by the country where the UE is deployed. These power limitations may provide an upper bound on the UL and/or DL bandwidth attainable by the UE. When one or more further UEs having respective network connections are available for use, it may be beneficial to aggregate the capabilities of the UEs.

### SUMMARY

Some exemplary embodiments are related to a processor of a first user equipment (UE) configured to perform operations. The operations include establishing a device-to-device (D2D) connection with a second UE, generating internet protocol (IP) packets for uplink (UL) transmission to a network and identifying a quality of service (Qos) flow for the packets, encapsulating each packet with a header comprising a Qos flow identifier (QFI), transmitting a first portion of the encapsulated packets to the network via a first radio link and transmitting a second portion of the encapsulated packets to the second UE via the D2D connection for transmission to the network via a second radio link of the second UE.

Other exemplary embodiments are related to a processor of a first user equipment (UE) configured to perform operations. The operations include establishing a device-to-device (D2D) connection with a second UE, receiving a network configuration for aggregating radio resources of the first and second UEs, the network configuration including parameters for determining whether to distribute uplink (UL) packets to lower layers of the first UE for transmission to a network over a first radio link or to the second UE for transmission to the network over a second radio link of the second UE, generating internet protocol (IP) packets for UL transmission to a network, encapsulating each packet with a header comprising a sequence number and identifying information for the packet, transmitting a first portion of the encapsulated packets to the network via a first radio link and transmitting a portion of the encapsulated packets to the second UE for transmission to the network via a second radio link of the second UE.

Still further exemplary embodiments are related to a processor of a first user equipment (UE) configured to perform operations. The operations include establishing a device-to-device (D2D) connection with a second UE, receiving internet protocol (IP) packets from the first UE, wherein each packet is encapsulated with a header comprising a quality of service (Qos) flow identifier (QFI), processing the encapsulated packets and identifying the QFI and transmitting the encapsulated packets to a network via a radio link.

Additional exemplary embodiments are related to a processor of a base station configured to perform operations. The operations include configuring a first user equipment (UE) for aggregating radio resources of the first UE and a second UE, the configuration including parameters for the UE to determine whether to distribute uplink (UL) packets to lower layers of the first UE for transmission to the base station over a first radio link or to the second UE for transmission to the base station over a second radio link of the second UE, receiving a first portion of encapsulated internet protocol (IP) packets from the first UE via the first radio link, receiving a second portion of encapsulated IP packets from the second UE via the second radio link and reordering the received encapsulated IP packets based on a sequence number included in a header of each packet.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary network base station according to various exemplary embodiments.

FIG. 4 shows an exemplary network arrangement for UE aggregation operations according to various exemplary embodiments described herein.

FIG. 5 shows a protocol stack arrangement for a primary UE and a secondary UE in a UE aggregation arrangement according to various exemplary embodiments described herein.

FIG. 6 shows an exemplary method for UE aggregation operations according to various exemplary embodiments described herein.

### DETAILED DESCRIPTION

The exemplary embodiments may be further understood with reference to the following description and the related appended drawings, wherein like elements are provided with the same reference numerals. The exemplary embodiments relate to operations for aggregating the transmit and/or receive capabilities of two or more UEs for data exchanges with a network. The exemplary embodiments are described with respect to a primary UE having a device-to-device (D2D) communication link to a secondary UE, and both the primary and secondary UEs having a radio link with a network. According to some aspects, the primary UE may split UL traffic between the radio links of the primary UE and the secondary UE to utilize the radio resources of both UEs. The primary UE may transmit certain uplink (UL) packets to the network via a primary radio link and distribute certain other UL packets to the secondary UE via the D2D link for transmission to the network via a secondary radio link. In a similar manner, downlink (DL) traffic for the primary UE may be split between the primary link and the secondary link, wherein the secondary UE forwards DL packets received from the network to the primary UE.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

Additionally, the UE as described herein may refer to a primary UE configured for a first subset of UE aggregation functionalities or one or more secondary UEs configured for a second subset of UE aggregation functionalities. However, the person skilled in the art would understand that the functionalities of the primary UE and the secondary UE may be included in a single UE, and that the UEs as described herein are not limited to operation as only a primary UE or a secondary UE in a UE aggregation operation.

The exemplary embodiments are also described with regard to a 5G New Radio (NR) network. However, reference to a 5G NR network is merely provided for illustrative purposes. The exemplary embodiments may be utilized with any network including a Long Term Evolution (LTE) network, to be explained below. Therefore, the 5G NR network as described herein may represent any type of network that can implement a UE aggregation functionality in a similar manner as described herein.

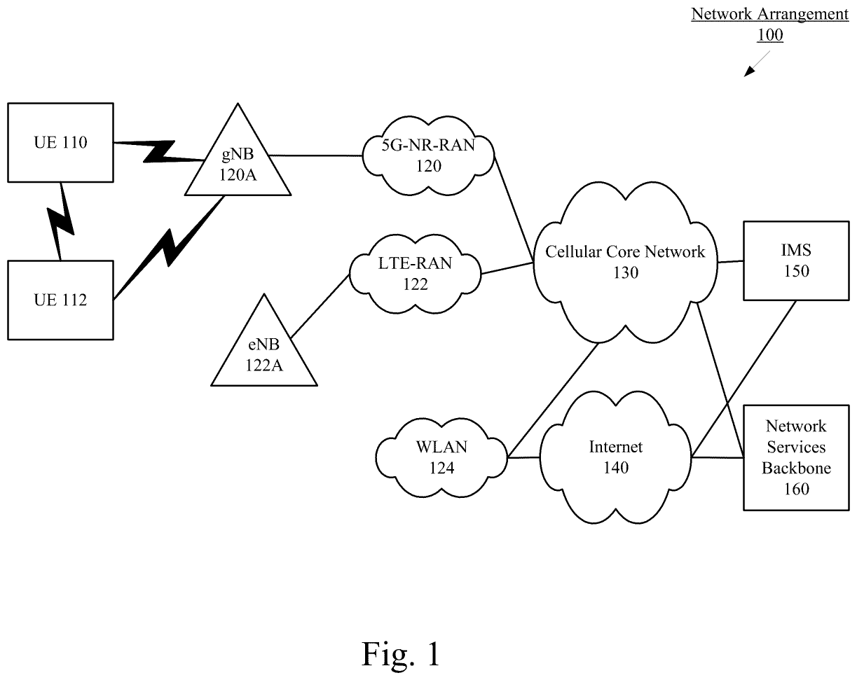

FIG. 1 shows an exemplary network arrangement 100 according to various exemplary embodiments. The exemplary network arrangement 100 includes UEs 110, 112. Those skilled in the art will understand that the UEs 110, 112 may be any type of electronic component that is configured to communicate via a network, e.g., a component of a connected car, a mobile phone, a tablet computer, a smartphone, a phablet, an embedded device, a wearable, an Internet of Things (IOT) device, etc.

Throughout this description, the terms UE 110, UE and transmitting device may be used interchangeably. Additionally, the terms UE 112, further UE and receiving device may also be used interchangeably. It should also be understood that an actual network arrangement may include any number of UEs being used by any number of users. Thus, the example of two UEs 110, 112 is merely provided for illustrative purposes.

The UEs 110, 112 may communicate directly with one or more networks. In the example of the network configuration 100, the networks with which the UEs 110, 112 may wirelessly communicate are a 5G NR radio access network (5G NR-RAN) 120, an LTE radio access network (LTE-RAN) 122 and a wireless local access network (WLAN) 124. These types of networks may support sidelink communication, e.g. over a 3GPP-specified sidelink (SL). However, the UE 110 may also communicate with other types of networks and the UE 110 may also communicate with networks over a wired connection. Therefore, the UEs 110, 112 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UEs 110, 112 may connect to the 5G NR-RAN via the gNB 120A. The gNB 120A may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. Reference to a single gNB 120A is merely for illustrative purposes. The exemplary embodiments may apply to any appropriate number of gNBs. The UEs 110, 112 may also connect to the LTE-RAN 122 via the eNB 122A.

Those skilled in the art will understand that any association procedure may be performed for the UEs 110, 112 to connect to the 5G NR-RAN 120 and the LTE-RAN 122. For example, as discussed above, the 5G NR-RAN 120 and the LTE-RAN 122 may be associated with a particular cellular provider where the UEs 110, 112 and/or the user thereof has a contract and credential information (e.g., stored on a SIM card). Upon detecting the presence of the 5G NR-RAN 120, the UEs 110, 112 may transmit the corresponding credential information to associate with the 5G NR-RAN 120. More specifically, the UEs 110, 112 may associate with a specific base station (e.g., the gNB 120A of the 5G NR-RAN 120, the eNB 122A of the LTE-RAN 122).

The UEs 110, 112 may also communicate with one another directly using a device-to-device (D2D) communications link. This D2D link may comprise e.g., a sidelink (SL), a wired connection, Wifi, Bluetooth, etc. In the D2D link, the information and/or data transmitted directly from one endpoint to the other endpoint (e.g., from the UE 110 to the UE 112) does not go through a cell (e.g., gNB 120A, eNB 122A). When a sidelink is configured, the UEs 110, 112 may receive information from a cell regarding how the sidelink is to be established, maintained and/or utilized. Thus, a network (e.g., the 5G NR-RAN 120, LTE-RAN 122) may control the sidelink. In other embodiments, the UEs 110, 112 may control the sidelink. Regardless of the nature of the D2D link, the UEs 110, 112 may maintain a downlink/uplink to a currently camped cell (e.g., gNB 120A, eNB 122A) and a D2D link to the other UE simultaneously. Although only two UEs 110, 112 are shown, the exemplary embodiments described herein may extend to additional UEs, as will be described below.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

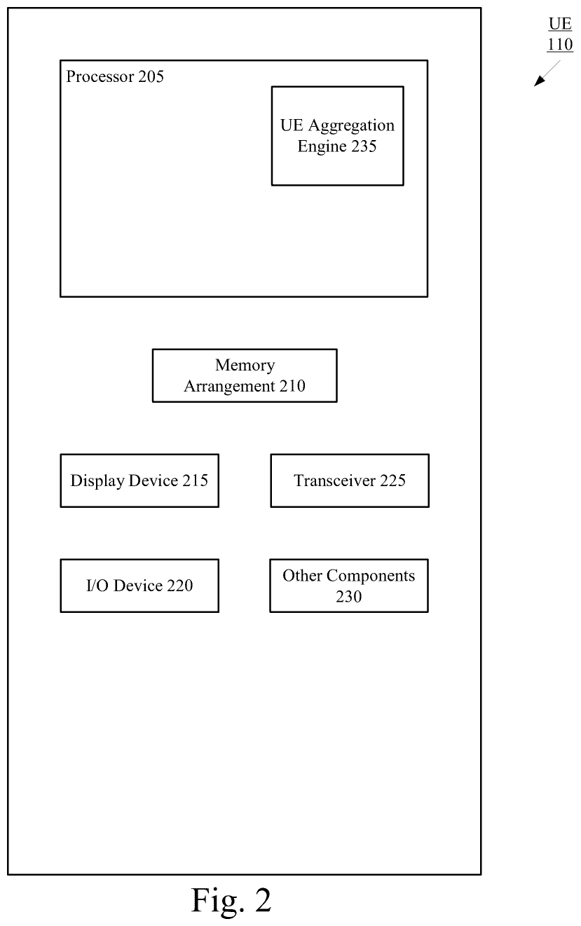

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225, and other components 230. The other components 230 may include, for example, a SIM card, an embedded SIM (eSIM), an audio input device, an audio output device, a power supply, a data acquisition device, ports to electrically connect the UE 110 to other electronic devices, etc. The UE 110 illustrated in FIG. 2 may also represent the UE 112.

The processor 205 may be configured to execute a plurality of engines of the UE 110. For example, the engines may include a UE aggregation engine 235. According to some aspects of the exemplary embodiments, the UE aggregation engine 235 may be considered a new protocol layer located in between the IP layer and the SDAP layer (or PDCP layer, for some LTE devices) in the UE user plane.

For a primary UE (e.g., UE 110), the UE aggregation engine 235 may perform operations including receiving UL traffic from the IP layer and determining whether to transmit the UL packets via a primary network link between the primary UE (e.g., UE 110) and the network or to distribute the UL traffic to a secondary UE (e.g., UE 112) for transmission via a secondary network link between the secondary UE 112 and the network. The primary and secondary UEs 110, 112 may communicate via a device-to-device (D2D) link, wherein the primary UE transmits some portion of UL packets to the second UE, which then forwards the packets to the network via the second network link.

For the primary UE 110, the UE aggregation engine 235 may perform further operations including adding an aggregation header (e.g., generic routing encapsulation (GRE) header) to the IP packets (encapsulating the packets). The primary UE 110 may receive a network configuration for directing the flow of the IP packets to the primary link or the secondary link, to be explained in further detail below.

For the secondary UE 112, the UE aggregation engine 235 may perform operations including receiving the encapsulated UL packets and re-transmitting the packets via the secondary link based on the information included in the aggregation header. The UE aggregation engine 235 may receive a network configuration establishing the aggregation functionality for the secondary UE 112.

The UE aggregation functionalities of the primary UE 110 and the secondary UE 100 described above may be included in both UEs 110, 112. The distinction between the operations performed by the UEs 110, 112 is provided only for illustrative purposes with respect to the operation of the exemplary embodiments, wherein one UE is configured as a primary UE and one or more further UEs are configured as secondary UEs.

The above referenced engines each being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the WLAN 122, etc. Accordingly, the transceiver 225 may operate on a variety of different frequencies or channels (e.g., set of consecutive frequencies).

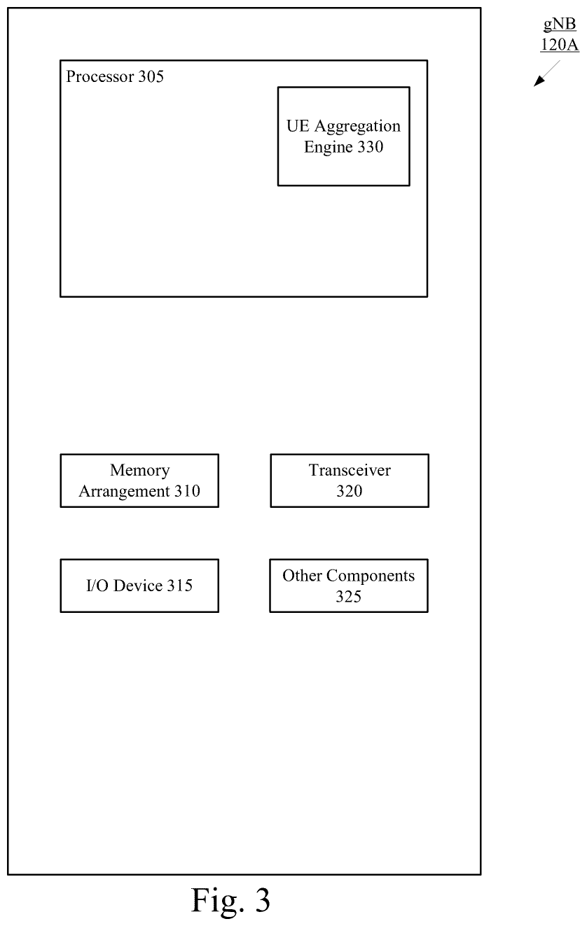

FIG. 3 shows an exemplary network base station, in this case gNB 120A, according to various exemplary embodiments. As noted above with regard to the UE 110, the gNB 120A may represent a serving cell for the UE 110. The gNB 120A may represent any access node of the 5G NR network through which the UE 110 may establish a connection and manage network operations.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a UE aggregation engine 330 configured to perform operations for the gNB 120A including configuring the UE aggregation functionality for the primary and secondary UEs. For example, the gNB 120A may configure aggregation layers for the primary and secondary UEs that control the flow of traffic to/from the primary UE. The gNB 120A may additionally receive the encapsulated packets from the primary and secondary UEs and reorder the packets according to the sequence number and the identifying information, e.g., Qos flow ID, included in the aggregation header. The aggregation functionality described herein may be abstracted as an “Aggregation layer,” similar to the UEs 110, 112.

The functionality of the UE aggregation engine 330 may be implemented via one or more applications, may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary aspects may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UE 110 and any other UE in the system 100. The transceiver 325 may operate on a variety of different frequencies or channels (e.g., set of consecutive frequencies). Therefore, the transceiver 325 may include one or more components (e.g., radios) to enable the data exchange with the various networks and UEs.

Various mechanisms exist by which a UE may transmit/receive data over multiple different communications paths. For example, in dual-connectivity (DC) operation, a UE is configured to transmit and receive on a plurality of component carriers (CCs) corresponding to cells associated with different RATs, e.g., EN-DC operation wherein the UE uses a master cell group (MCG) corresponding to LTE and a secondary cell group (SCG) corresponding to 5G NR, or NE-DC operation, where the MCG corresponds to NR and the SCG corresponds to LTE.

In another example, in LTE/WLAN Radio Level Integration Using IPSec Tunnel (LWIP) operation, the UE may use WLAN radio resources via IPsec protocol tunneling to authenticate and encrypt packets (e.g., IP packets) sent over the WLAN network connection. IPsec tunneling may include encapsulating the entirety of original IP packets and adding a new packet header, thereby protecting the original header of the IP packets. In the uplink, IP packets may be encapsulated in a GRE packet (formally, in the LWIPEP layer), and the LWIPEP packets can then be sent over either LTE or WLAN (via a secure IP tunnel).

The generic routing encapsulation (GRE) protocol provides a means for encapsulating data packets using one protocol inside the packets of another protocol to establish a direct point-to-point connection across a network, otherwise referred to as GRE tunneling. A first GRE entity may add a GRE header to received data packets including information for the origin/destination of the packet and transmit the encapsulated packets to a second GRE entity for e.g. decryption and/or further processing.

According to various exemplary embodiments described herein, a UE aggregation functionality is configured for a primary UE and at least one secondary UE wherein UL traffic generated by the primary UE, e.g., IP packets, may be routed to the network via the radio link of the primary UE or the radio link of the secondary UE.

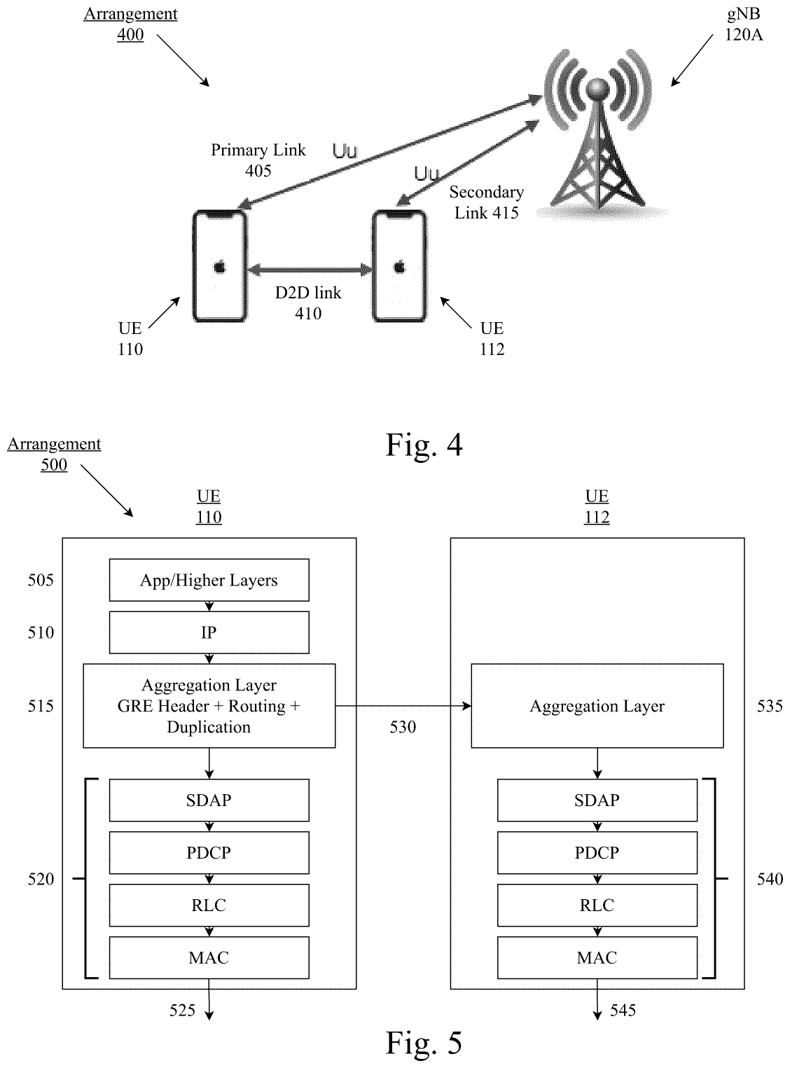

FIG. 4 shows an exemplary network arrangement 400 for UE aggregation operations according to various exemplary embodiments described herein. Similar to the network arrangement 100 described above in FIG. 1, the network arrangement 400 includes two UEs, e.g., UE 110 and UE 112, and a network base station, e.g., gNB 120A. In this example, the UE 110 is a primary UE and the UE 112 is a secondary UE in the UE aggregation configuration. However, as described above, the respective UEs 110, 112 may operate as either a primary UE or a secondary UE, depending on UE capability and/or the network configuration.

As shown, the UE 110 (primary UE) is connected to the gNB 120A via a primary link 405 and to the UE 112 (secondary UE) via a D2D link 410, e.g., a wired connection, a WLAN link, a sidelink, etc. The UE 112 is connected to the gNB 120A via a secondary link 415. Although only two UEs 110, 112 are shown, additional UEs may be configured as secondary UEs and have respective D2D links to the primary UE 110 and radio links to the gNB 120A.

According to various exemplary embodiments to be described below, the primary UE 110 may transmit UL data packets to the gNB 120A via the primary link 405 or to the secondary UE 112 via the D2D link 410. The secondary UE 112, upon receiving the UL packets, can forward the packets to the gNB 120A. In this way, the primary UE 110 can aggregate the bandwidth of the secondary UE 112 with its own bandwidth to transmit/receive a greater amount of data via the primary and secondary links 405, 415 than would be possible using only the primary link 405. The exemplary embodiments are agnostic to the type of D2D link used between the primary and secondary UEs 110, 112.

The aggregation functionality may be abstracted as a new protocol layer, referred to herein as an “Aggregation layer” added between the IP layer and the UE user plane protocol stack, e.g., the SDAP of a 5G UE (or some LTE UEs) or the PDCP of some LTE UEs. The Aggregation layer is designed to have a minimal impact on the existing user plane (SDAP, PDCP, RLC) access stratum (AS) layers and may support both aggregation and duplication. As will be described in further detail below, the network can configure the Aggregation layer to control how the UL traffic is distributed.

A tunneling mechanism is used to encapsulate the IP packets and transmit the IP packets over the multiple paths. The tunneling mechanism is described herein as GRE, however any protocol capable of carrying a Sequence field and a Key field, as described in further detail below, can be used. For example, the Generic Network Virtualization Encapsulation (GENEVE) tunneling mechanism may be used. To encapsulate the IP packets, the Aggregation layer adds a GRE header to the IP packets.

According to one aspect, the exemplary GRE header contains both a Sequence field and a Key field. The Sequence field provides an ordering for the IP packets, and the Key field provides identifying information for the packet. In one embodiment, when the network is a 5G NR RAN or an LTE network using the SDAP layer, the Key field may include a quality of service (QOS) flow identifier (ID) (QFI) and either a data radio bearer (DRB) ID or a protocol data unit (PDU) session ID for the IP packet. In another embodiment, when the network is an LTE network not using the SDAP layer (wherein the PDCP is the highest layer in the user plane), the Key field may include a DRB ID.

In some exemplary embodiments, the above-described fields included in the GRE header result in a 12 byte overhead, which is an acceptable overhead particularly when the packet size is large and when reliability is more important than capacity.

The encapsulated packets may be transmitted from the primary UE to the network over the primary link or to the secondary UE over the D2D link. Specifically, to be described below, the Aggregation layer of the primary UE may transmit the packets to the Aggregation layer of the secondary UE, which may process the GRE header and forward the packets to the network over the secondary link based on the identifying information included in the header and/or based on a network configuration for e.g., packet filtering.

FIG. 5 shows a protocol stack arrangement 500 for a primary UE and a secondary UE in a UE aggregation arrangement according to various exemplary embodiments described herein. Similar to above, in the arrangement 500, the UE 110 functions as the primary UE and the UE 112 functions as the secondary UE. Each of the UEs 110, 112 may be configured for UE aggregation functionality using an Aggregation layer located in the UE protocol stack below the IP layer and above the user plane (e.g., the SDAP, PDCP, RLC and MAC layers in NR and some LTE releases, or the PDCP, RLC and MAC layers in some other LTE releases). The primary UE 110 has a primary radio link 525 with the network and a D2D link 530 with the secondary UE 112, and the secondary UE 112 has a secondary radio link 545 with the network.

The protocol stack of the primary UE 110 comprises an application layer/higher layers 505 which may generate UL data packets for transmission to the network. For example, a user of the UE 110 may interact with software applications being executed by, for example, the processor of the UE. Below the higher layers 505 is the IP layer 510, which may perform packet addressing and routing by e.g., assigning IP addresses to the data packets received from the higher layers 505 and transmitting the packets to the Aggregation layer 515.

The Aggregation layer 515 of the primary UE 110 is configured for various functionalities for executing the UE aggregation operations, as described above. In one aspect, the Aggregation layer 515 identifies information for the UL packets received from the higher layers 505, 510, e.g., QFI and/or DRB ID or PDU session ID, and adds the GRE header to the packets including the sequence and key information. In some embodiments, the Aggregation layer 515 can determine which Qos flows can be aggregated, which Qos flows can be duplicated, and which Qos flows can be both aggregated and duplicated, for example when multiple secondary UEs 112 are involved. The Aggregation layer 515 may then submit the encapsulated packets to the lower layers 520 of the primary UE 110, e.g., the SDAP layer, or to the Aggregation layer 535 of the secondary UE 112 over the D2D link 530. The Aggregation layer 535 of the secondary UE 112 may process the encapsulated packets and transmit the packets to the lower layers 545 of the secondary UE 112 for transmission to the network. For example, the secondary UE 112 may use the information included in the GRE header or a network configuration to direct the traffic to the network in accordance therewith.

When the network (e.g., gNB 120A) receives the packets via the primary and secondary links 525, 545, the gNB 120A processes the GRE header, identifies the Qos flow and reorders the packets based on the Sequence numbers.

The network may be aware of the identifying information for the packet, e.g., the QFI and the DRB ID or PDU session ID, when the packet is received. For example, DRBs may be mapped one-to-one to logical channels, and the network knows which logical channel the received data belongs to. Thus, in some embodiments, the Key field may be dropped from the GRE header for the UL transmissions via the primary and secondary links 525, 545 to reduce the overhead of the UE aggregation operation. Similarly, for DL transmissions to the UE, the UE may be aware of the identifying information for the packet so the Key field may be dropped from the GRE header.

The Aggregation layer is configured to distribute the data flows via the multiple paths based on a network configuration. The network can configure which Qos flows are to be processed by the Aggregation layer, how many UEs are involved, and whether and how to perform packet duplication. The packets can be distributed to the UEs in multiple ways for transmission to the network.

In one embodiment, the network may configure packet duplication for the primary UE, wherein the first UE duplicates the encapsulated packets and transmits the encapsulated packets via the first radio link and transmits the duplicated packets to the second UE for transmission via the second radio link. The packet duplication can be configured via RRC signaling and activated via RRC or MAC CE.

In another embodiment, a threshold may be provided wherein, when a UL data buffer size is less than the threshold, the primary UE transmits via a prioritized link, e.g., the primary link. If the buffer size is above the threshold, the primary UE may distribute the traffic via both the primary and secondary links.

In another embodiment, the network may restrict the traffic flow based on QFI or DRB ID. For example, the network may configure which Qos flows/DRBs can be aggregated and which Qos flows/DRBs can be submitted by the secondary UEs. In some embodiments, the network may configure which Qos flows can be aggregated, which Qos flows can be duplicated, and which Qos flows can be both aggregated and duplicated, for example when multiple secondary UEs are involved.

In still another embodiment, the network may provide a splitting ratio and a window per QFI/DRB. For example, the network may configure a splitting ratio and a time window wherein 40% of the packets in a certain time window are routed to the primary UE and 60% of the packets in the window are routed to the secondary UE. In another example, the network may configure a splitting ratio and a packet count window wherein 30% of packets in every set of 1000 packets are routed to the primary UE, 30% of the packets are routed to a first secondary UE, and 40% of the packets are routed to a second secondary UE.

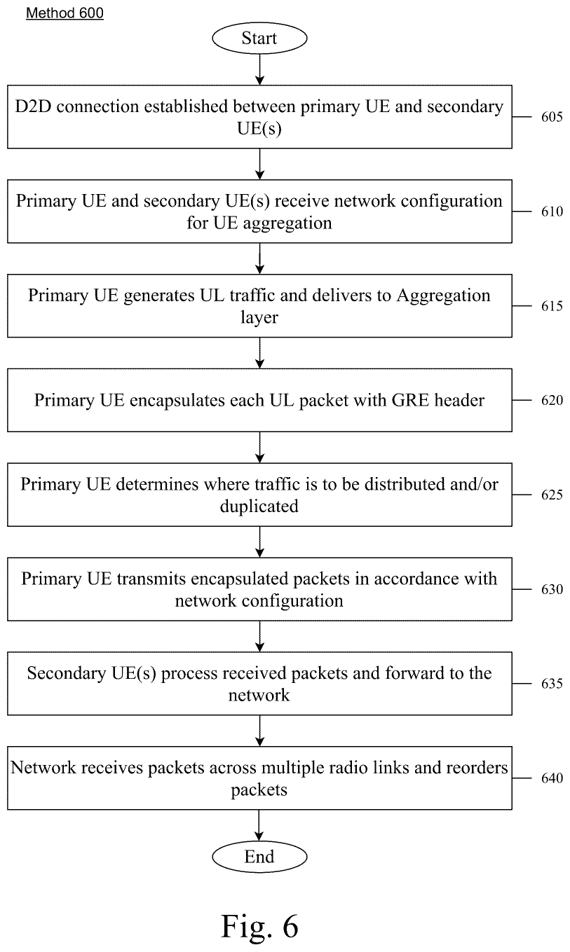

FIG. 6 shows an exemplary method 600 for UE aggregation operations according to various exemplary embodiments described herein.

In 605, a primary UE and at least one secondary UE establish a D2D connection. The D2D connection may comprise a sidelink, a wired connection, Wifi, Bluetooth, or any other D2D connection. The primary and one or more secondary UEs are each additionally connected to a network, e.g., the 5G NR RAN, via a network base station.

In 610, the primary and secondary UEs receive a network configuration for UE aggregation operation. The configuration includes an identification of the primary UE and one or more secondary UEs and a protocol layer abstraction (Aggregation layer) for performing the respective aggregation functionalities. For example, the Aggregation layer of the primary UE is configured for receiving and encapsulating IP packets and routing the packets via the multiple UEs for transmission to the network. The primary UE may be further configured with rules for packet transmission via the multiple paths, for example based on QFI or DRB ID. The Aggregation layers of the secondary UEs may be configured to receive the encapsulated packets, determine the identifying information for the packet and transmit the packets via respective secondary radio links.

In 615, the primary UE generates UL traffic that is delivered from the IP layer to the Aggregation layer.

In 620, the primary UE encapsulates each UL packet with a header e.g., a GRE header. The GRE header includes a Sequence and Key field, as described above.

In 625, the primary UE determines whether the UL traffic can be aggregated and/or duplicated across the secondary UE (s) and, when it can be aggregated/duplicated, which UE (s) the traffic should be routed to. The primary UE makes this determination based on the network configuration. For example, the network may configure certain Qos flows or DRBs for aggregation/duplication. In another example, the network may configure a buffer size threshold wherein, when the buffer size is below the threshold, a certain radio link is prioritized. In still another example, the network may configure a splitting ratio for distributing the packets across the UEs.

In 630, the primary UE transmits the encapsulated packets in accordance with the network configuration. The packets may be transmitted to the lower layers of the primary UE for transmission to the network or to the Aggregation layer (s) of the secondary UEs.

In 635, the secondary UEs process any packets received from the primary UE and forward the packets to the network in accordance with the information included in the GRE header and/or based on a network configuration for e.g. packet filtering. In some embodiments, the identifying information (QFI, DRB ID, PDU session ID) can be removed from the GRE header prior to forwarding the packet.

In 640, the network receives the packets across the multiple radio links and reorders the packets based on the Sequence field in the GRE header and the Qos flow for the packet.

The exemplary embodiments above are described primarily with respect to UL transmissions from a UE. However, a similar mechanism may be used for DL transmissions to a UE. For example, a base station may transmit encapsulated DL packets across multiple radio links of connected UEs. DL packets received at the secondary UEs may be processed and forwarded to the primary UE based on the information included in the GRE header, and the primary UE may reorder the packets based on sequence and QoS flow.

### Examples

In a first example, a first user equipment (UE) comprises a transceiver configured to communicate with a network and a processor communicatively coupled to the transceiver and configured to perform operations comprising establishing a device-to-device (D2D) connection with a second UE, generating internet protocol (IP) packets for uplink (UL) transmission to the network and identifying a quality of service (Qos) flow for the packets, encapsulating each packet with a header comprising a Qos flow identifier (QFI), transmitting a first portion of the encapsulated packets to the network via a first radio link and transmitting a second portion of the encapsulated packets to the second UE via the D2D connection for transmission to the network via a second radio link of the second UE.

In a second example, a first user equipment (UE) comprises a transceiver configured to communicate with a network and a processor communicatively coupled to the transceiver and configured to perform operations comprising establishing a device-to-device (D2D) connection with a second UE, receiving a network configuration for aggregating radio resources of the first and second UEs, the network configuration including parameters for determining whether to distribute uplink (UL) packets to lower layers of the first UE for transmission to a network over a first radio link or to the second UE for transmission to the network over a second radio link of the second UE, generating internet protocol (IP) packets for UL transmission to a network, encapsulating each packet with a header comprising a sequence number and identifying information for the packet, transmitting a first portion of the encapsulated packets to the network via a first radio link and transmitting a portion of the encapsulated packets to the second UE for transmission to the network via a second radio link of the second UE.

In a third example, a first user equipment (UE) comprises a transceiver configured to communicate with a network and a processor communicatively coupled to the transceiver and configured to perform operations comprising establishing a device-to-device (D2D) connection with a second UE, receiving internet protocol (IP) packets from the first UE, wherein each packet is encapsulated with a header comprising a quality of service (Qos) flow identifier (QFI), processing the encapsulated packets and identifying the QFI and transmitting the encapsulated packets to a network via a radio link.

In a fourth example, a base station comprises a transceiver configured to communicate with a first user equipment (UE) and a second UE, and a processor communicatively coupled to the transceiver and configured to perform operations comprising configuring the first UE for aggregating radio resources of the first UE and the second UE, the configuration including parameters for the UE to determine whether to distribute uplink (UL) packets to lower layers of the first UE for transmission to the base station over a first radio link or to the second UE for transmission to the base station over a second radio link of the second UE, receiving a first portion of encapsulated internet protocol (IP) packets from the first UE via the first radio link, receiving a second portion of encapsulated IP packets from the second UE via the second radio link and reordering the received encapsulated IP packets based on a sequence number included in a header of each packet.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a first user equipment (UE) configured to perform operations comprising:
establishing a device-to-device (D2D) connection with a second UE;
generating internet protocol (IP) packets for uplink (UL) transmission to a network and identifying a quality of service (QOS) flow for the packets;
encapsulating each packet with a header comprising a QoS flow identifier (QFI);
transmitting a first portion of the encapsulated packets to the network via a first radio link; and
transmitting a second portion of the encapsulated packets to the second UE via the D2D connection for transmission to the network via a second radio link of the second UE.

2. The processor of claim 1, wherein the header further comprises a sequence number and a data radio bearer (DRB) ID or a protocol data unit (PDU) session ID identified from the IP packet.

3. The processor of claim 1, wherein the operations further comprise:
receiving a network configuration including parameters for determining whether to distribute the encapsulated packets to lower layers of the first UE for transmission to a network via the first radio link or to the second UE for transmission to the network via the second radio link.

4. The processor of 3, wherein the network configuration indicates a buffer size threshold, wherein, when a buffer size of the first UE is below the threshold, the first UE transmits via a prioritized link of the first and second radio links and, when the buffer size is above the threshold, the first UE transmits via both the first and second radio links.

5. The processor of claim 3, wherein the network configuration indicates packet duplication, wherein the first UE duplicates the encapsulated packets and transmits the encapsulated packets and the duplicated packets via both the first and second radio links.

6. The processor of claim 5, wherein the packet duplication is configured by radio resource control (RRC) signaling and activated by RRC signaling or a medium access control control element (MAC-CE).

7. The processor of claim 3, wherein the network configuration indicates which QoS flows can be aggregated or duplicated.

8. The processor of claim 3, wherein the network configuration indicates a splitting ratio for splitting the encapsulated packets across the first and second radio links.

9. The processor of claim 8, wherein the splitting ratio is associated with a time window or packet window.

10. The processor of claim 1, wherein the header is a generic routing encapsulation (GRE) protocol header.

11. A processor of a first user equipment (UE) configured to perform operations comprising:
establishing a device-to-device (D2D) connection with a second UE;
receiving a network configuration for aggregating radio resources of the first and second UEs, the network configuration including parameters for determining whether to distribute uplink (UL) packets to lower layers of the first UE for transmission to a network over a first radio link or to the second UE for transmission to the network over a second radio link of the second UE;
generating internet protocol (IP) packets for UL transmission to a network;
encapsulating each packet with a header comprising a sequence number and identifying information for the packet;
transmitting a first portion of the encapsulated packets to the network via a first radio link; and
transmitting a portion of the encapsulated packets to the second UE for transmission to the network via a second radio link of the second UE.

12. The processor of 11, wherein the network configuration indicates a buffer size threshold, wherein, when a buffer size of the first UE is below the threshold, the first UE transmits via a prioritized link of the first and second radio links and, when the buffer size is above the threshold, the first UE transmits via both the first and second radio links.

13. The processor of claim 11, wherein the network configuration indicates packet duplication, wherein the first UE duplicates the encapsulated packets and transmits the encapsulated packets and the duplicated packets via both the first and second radio links.

14. The processor of claim 13, wherein the packet duplication is configured by radio resource control (RRC) signaling and activated by RRC signaling or a medium access control control element (MAC-CE).

15. The processor of claim 11, wherein the network configuration indicates which QoS flows can be aggregated or duplicated.

16. The processor of claim 11, wherein the network configuration indicates a splitting ratio for splitting the encapsulated packets across the first and second radio links.

17. The processor of claim 16, wherein the splitting ratio is associated with a time window or packet window.

18. The processor of claim 11, wherein the header is a generic routing encapsulation (GRE) protocol header.

19. A processor of a first user equipment (UE) configured to perform operations comprising:
establishing a device-to-device (D2D) connection with a second UE;
receiving internet protocol (IP) packets from the first UE, wherein each packet is encapsulated with a header comprising a quality of service (QOS) flow identifier (QFI);
processing the encapsulated packets and identifying the QFI; and
transmitting the encapsulated packets to a network via a radio link.

20. The processor of claim 19, wherein the header further comprises a sequence number and a data radio bearer (DRB) ID or a protocol data unit (PDU) session ID identified from the IP packet.

21-31. (canceled)
